(19) United States
(12) Patent Application Publication
(10) Pub. No.: US 2026/0012723 A1
(43) Pub. Date: Jan. 8, 2026

(54) WEARABLE DEVICE, METHOD, AND STORAGE MEDIUM FOR CONTROLLING MICROPHONES

(71) Applicant: Samsung Electronics Co., Ltd., Suwon-si (KR)

(72) Inventors: Yunguk LEE, Suwon-si (KR); Yeongrae JO, Suwon-si (KR); Inseong LEE, Suwon-si (KR); Jaesung SHIM, Suwon-si (KR)

(21) Appl. No.: 19/240,795

(22) Filed: Jun. 17, 2025

(30) Foreign Application Priority Data
Jul. 8, 2024 (KR) 10-2024-0089968
Sep. 13, 2024 (KR) 10-2024-0125931

(51) Int. Cl. H04R 1/10; H04R 1/08

(52) U.S. Cl. CPC H04R 1/1083; H04R 1/086; H04R 1/1016; H04R 2410/07

(57) ABSTRACT

A wearable device comprises at least one processor, memory storing instructions, a plurality of microphones, and a speaker. The instructions that, when executed by the at least one processor individually or collectively, cause the wearable device to: execute an ambient sound function, perform a measurement with respect to a sound of an ambient environment of a user using a first outer microphone, refrain from performing a measurement with respect to the sound of the ambient environment of the user using a second outer microphone, obtain sound data according to the measurement performed using the first outer microphone, in accordance with a level of the sound data less than or equal to a reference level, output a sound of the ambient environment based on the sound data, and in accordance with the level of the sound data greater than the reference level, perform the measurement using the second outer microphone.

### CROSS-REFERENCE TO RELATED APPLICATION(S)

This application is based on and claims priority under 35 U.S.C. § 119(a) of a Korean patent application number 10-2024-0089968, filed on Jul. 8, 2024, in the Korean Intellectual Property Office, and of a Korean patent application number 10-2024-0125931, filed on Sep. 13, 2024, in the Korean Intellectual Property Office, the disclosure of each of which is incorporated by reference herein in its entirety.

### BACKGROUND

### 1. Field

The disclosure relates to a wearable device, a method, and a storage medium for controlling microphones.

### 2. Description of Related Art

An electronic device may include a wearable device that may be worn by a user. For example, the wearable device may be worn on a body part of the user. For example, the body part may include an ear portion of the user.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a wearable device, a method, and a storage medium for controlling microphones.

Additional aspects will be set forth in part in the description which follows and, in part, will be apparent from the description, or may be learned by practice of the presented embodiments.

In accordance with an aspect of the disclosure, a wearable device being wearable by an ear portion of a user is provided. The wearable device includes at least one processor including processing circuitry, memory, including one or more storage media, storing one or more programs, a plurality of microphones including an inner microphone positioned toward inside of a space formed by the wearable device and the ear portion, when the wearable device is worn by the ear portion, and a first outer microphone and a second outer microphone each positioned toward outside of the space, and a speaker, wherein the one or more programs include instructions that, when executed by the at least one processor individually or collectively, cause the wearable device to execute an ambient sound function, based on executing the ambient sound function: perform a measurement with respect to a sound of ambient environment of the user using the first outer microphone, and refrain from performing a measurement with respect to a sound of the ambient environment of the user using the second outer microphone, obtain sound data according to the measurement performed using the first outer microphone, and for providing the ambient sound function: in accordance with a level of the sound data less than or equal to a reference level for providing the ambient sound function, output, through the speaker, a sound of the ambient environment based on the sound data obtained using the first outer microphone, and in accordance with the level of the sound data greater than the reference level, perform the measurement with respect to a sound of ambient environment of the user using the second outer microphone.

In accordance with another aspect of the disclosure, a method performed by a wearable device being wearable by an ear portion of a user, the wearable device including a plurality of microphones including an inner microphone positioned toward inside of a space formed by the wearable device and the ear portion, and a first outer microphone and a second outer microphone each positioned toward outside of the space, and a speaker, when the wearable device is worn on the ear portion, may comprise executing an ambient sound function. The method may comprise, based on executing the ambient sound function, performing a measurement with respect to a sound of ambient environment of the user using the first outer microphone. The method may comprise, based on executing the ambient sound function, refraining from performing a measurement with respect to a sound of the ambient environment of the user using the second outer microphone. The method may comprise obtaining sound data according to the measurement performed using the first outer microphone. The method may comprise, in accordance with a level of the sound data less than or equal to a reference level for providing the ambient sound function, outputting, through the speaker, a sound of the ambient environment based on the sound data obtained using the first outer microphone. The method may comprise, in accordance with the level of the sound data greater than the reference level, performing the measurement with respect to a sound of ambient environment of the user using the second outer microphone.

In accordance with another aspect of the disclosure, a non-transitory computer-readable storage media may store one or more computer programs including instructions that, when executed by at least one processor of a wearable device individually or collectively, cause the wearable device to execute an ambient sound function, when the wearable device being wearable by an ear portion of a user is worn by the ear portion, the wearable device including a plurality of microphones including an inner microphone positioned toward inside of a space formed by the wearable device and the ear portion, and a first outer microphone and a second outer microphone each positioned toward outside of the space, and a speaker. The non-transitory computer-readable storage media may store one or more computer programs including instructions that, when executed by the at least one processor individually or collectively, cause the wearable device to, based on executing the ambient sound function, perform a measurement with respect to a sound of ambient environment of the user using the first outer microphone. The non-transitory computer-readable storage media may store one or more computer programs including instructions that, when executed by the at least one processor individually or collectively, cause the wearable device to, based on executing the ambient sound function, refrain from performing a measurement with respect to a sound of the ambient environment of the user using the second outer microphone. The non-transitory computer-readable storage media may store one or more computer programs including instructions that, when executed by the at least one processor individually or collectively, cause the wearable device to obtain sound data according to the measurement performed using the first outer microphone. The non-transitory computer-readable storage media may store one or more computer programs including instructions that, when executed by the at least one processor individually or collectively, cause the wearable device to, in accordance with a level of the sound data less than or equal to a reference level for providing the ambient sound function, output, through the speaker, a sound of the ambient environment based on the sound data obtained using the first outer microphone. The non-transitory computer-readable storage media may store one or more computer programs including instructions that, when executed by the at least one processor individually or collectively, cause the wearable device to, in accordance with the level of the sound data greater than the reference level, perform the measurement with respect to a sound of ambient environment of the user using the second outer microphone.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 illustrates an example block diagram of a wearable device according to an embodiment of the disclosure;

FIG. 3 illustrates an example of a housing of a wearable device according to an embodiment of the disclosure;

FIGS. 4 and 5 illustrate examples of an exploded perspective view of a wearable device according to various embodiments of the disclosure;

FIG. 6 illustrates an example of sound data of a user's ambient environment acquired by a wearable device when an ambient sound function is executed according to an embodiment of the disclosure;

FIG. 7 illustrates an example of an operation flow for a method of controlling external microphones that measure sound data according to an execution of an ambient sound function according to an embodiment of the disclosure; and

FIG. 8 illustrates an example of a time period for measuring a sound of an ambient environment through an external microphone according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various examples of the disclosure described below, a hardware approach will be described as an example. However, since various embodiments of the disclosure may include a technology that utilizes both the hardware-based approach and the software-based approach, the various embodiments are not intended to exclude the software-based approach.

Further, throughout the disclosure, an expression, such as e.g., ‘above (more than)’ or ‘below (less than)’ may be used to determine whether a specific condition is satisfied or fulfilled, but it is merely a description for expressing an example and is not intended to exclude the meaning of ‘more than or equal to’ or ‘less than or equal to’. A condition described as ‘more than or equal to’ may be replaced with an expression, such as ‘more than’, a condition described as ‘less than or equal to’ may be replaced with an expression, such as ‘less than’, and a condition described as ‘more than or equal to and below’ may be replaced with ‘more than and less than or equal to’, respectively. Further, hereinafter, ‘A’ to ‘B’ means at least one of the elements from A (inclusive of A) to B (inclusive of B).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

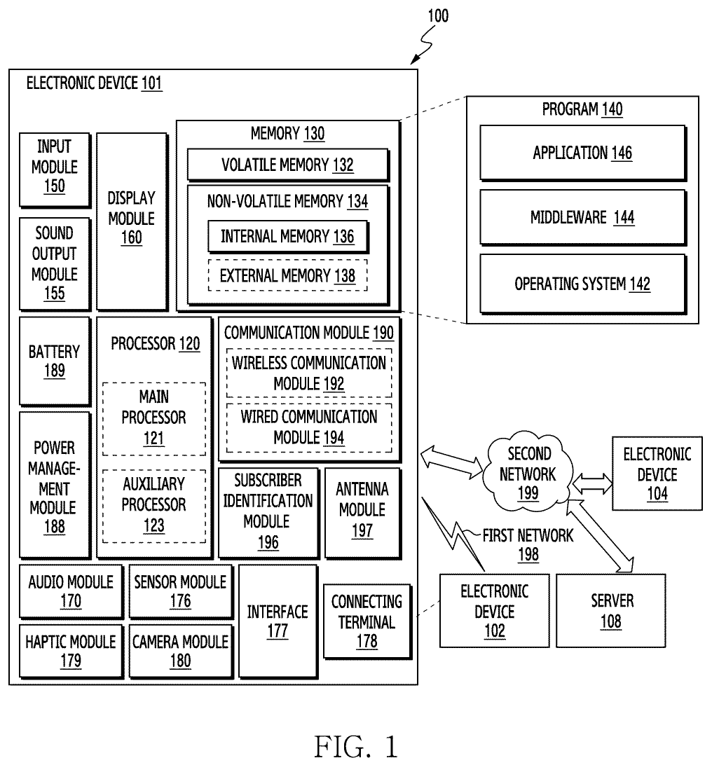

FIG. 1 is a block diagram of an electronic device in a network environment according to an embodiment of the disclosure.

FIG. 1 is a block diagram of an electronic device in a network environment 100 according to an embodiment. Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high-definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave band)) to address, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may be a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

A wearable device that outputs sound information may be worn on a user's body part (e.g., an ear part or an ear canal part). For example, the wearable device may be referred to as earbuds, earbud, earphone, or true wireless storage (TWS).

When the wearable device is worn on a user's body part, the probability (hereinafter, recognition rate) of the user recognizing a sound of the user's ambient environment (or physical environment, external environment, real-world environment) may be lowered. As a non-limiting example, while the wearable device is worn on the user's body part, the user's recognition rate of the sound may be lowered because the body part is covered by the wearable device (or passive noise cancellation, PNC). Further, as a non-limiting example, while the wearable device executes a function for blocking noise in the ambient environment (or active noise cancellation, ANC), the user's recognition rate of the sound may be lowered. In order to use the sound information (or media content) provided from the wearable device, the PNC or the ANC may be useful, but the user's recognition rate of the sound of the ambient environment may decrease. Accordingly, as the user's recognition rate of the sound of the ambient environment deteriorates, the user may be exposed to any dangerous situation (e.g., vehicle collision) or may have difficulty in communicating with other people.

As described above, in order to improve (or increase) the decreased recognition rate while the wearable device is worn on the user's body part, the wearable device may provide a function for providing a sound of an ambient environment to the user (or an ambient sound function, an ambient sound listening function, an external sound listening function). As a non-limiting example, the wearable device may output the sound of the ambient environment through a speaker (e.g., the sound output module 155) together with the sound information (or media content). When the ambient sound function is executed (or activated), the wearable device may receive the sound of the ambient environment via a microphone (e.g., the input module 150) and output the received sound through the speaker. As a non-limiting example, in the case of an environment in which the user is located in the ambient environment where there is a lot of noise (e.g., wind), the quality of the sound information provided to the user may be deteriorated depending on the execution of the ambient sound function.

When executing the ambient sound function, the wearable device may receive the sound of the ambient environment using all the microphones (or external microphones) included in the wearable device and perform processing of the received sound. The wearable device may provide the processed sound through a speaker. In this case, the processing may include a processing for removing noise (e.g., wind sound) included in the sound of the ambient environment. In order to perform the above processing, the wearable device may remove noise by using the received sounds (or sound data) using a plurality of microphones (or external microphones) of the wearable device. However, when executing the ambient sound function, the wearable device acquires (or measures or receives) the sound of the ambient environment using all the microphones of the wearable device regardless of a sound volume of the ambient environment (or the volume of noise in the ambient environment), so battery consumption of the wearable device may increase. In one example, when the noise of the sound of the ambient environment is low or non-existent, or when the ambient environment is a quiet space (e.g., a library), the removal (or reduction, suppression, prevention) of the noise of the sound may not be relatively necessary.

Hereinafter, when the ambient sound function is executed, the sound (or sound data) of the ambient environment may be measured using some of the plurality of microphones of the wearable device, and the rest of the microphone may be used to refrain from measuring the sound (or sound data) of the ambient environment (or cease, stop, bypass, skip). The disclosure may provide the ambient sound function based on the sound data measured using some of the microphones, or may determine to perform (or initiate or resume) the measurement of the sound (or sound data) using the rest of the microphones based on the sound data measured using some of the microphones. In other words, the disclosure may provide the ambient sound function by controlling the operation of at least one of the plurality of microphones of the wearable device depending upon the sound (or noise in the sound) of the ambient environment. Accordingly, the disclosure can increase the usage time of the wearable device by reducing the battery consumption (or current consumption of the microphone) of the wearable device and reducing the resources (e.g., software resources) used in the wearable device. In addition, the disclosure can smoothly provide the ambient sound function along with the increased usage time.

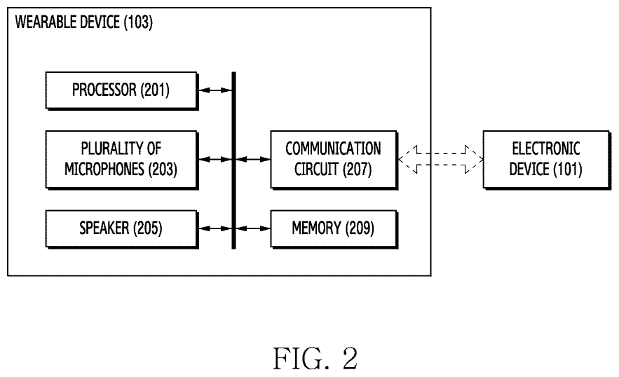

Hereinafter, in FIG. 2, an example block diagram of a wearable device according to the disclosure will be described.

FIG. 2 illustrates an example block diagram of a wearable device according to an embodiment of the disclosure.

FIG. 2 illustrates an example block diagram of a wearable device 103 worn on a user's body part. For example, the body part may include the user's ear part or an ear canal part. The wearable device 103 of FIG. 2 may be an example of the electronic device 102 connected to the electronic device 101 of FIG. 1.

Referring to FIG. 2, the wearable device 103 may be connected to the electronic device 101 of FIG. 1 based on a wired network and/or a wireless network. For example, the wired network may include a network such as Internet, local area network (LAN), wide area network (WAN), or a combination thereof. For example, the wireless network may include a network such as long term evolution (LTE), 5G new radio (NR), wireless fidelity (WiFi), Zigbee, near field communication (NFC), Bluetooth, Bluetooth low-energy (BLE), or a combination thereof. The wearable device 103 may be directly connected to the electronic device 101, or may be connected indirectly through one or more routers and/or an access point (AP).

Referring to FIG. 2, according to an embodiment, the wearable device 103 may include a processor 201, a plurality of microphones 203, a speaker 205, a communication circuit 207, and memory 209. However, embodiments of the disclosure are not limited thereto. For example, the processor 201, the plurality of microphones 203, the speaker 205, the communication circuit 207, and the memory 209 may be electronically and/or operatively connected to each other by a communication bus. Hereinafter, an operatively coupling of hardware components may mean that a direct or indirect connection between the hardware components is established by wire or wirelessly so that a second hardware component among those hardware components is controlled by a first hardware component. Although shown based on different blocks, the embodiments are not limited thereto, and some of the hardware components shown in FIG. 2 (e.g., the processor 201 and at least part of the communication circuit 207) may be included in a single integrated circuit such as, e.g., a system on chip (SoC) or a system in package (SIP). The type and/or number of hardware components included in the wearable device 103 are not limited to those shown in FIG. 2. For example, the wearable device 103 may include only some of the hardware components shown in FIG. 2.

According to an embodiment, the processor 201 of the wearable device 103 may include a hardware component for processing data based on one or more instructions. The hardware component for processing data may include, for example, an arithmetical and logic unit (ALU), a floating point unit (FPU), and/or a field programmable gate array (FPGA). For example, the hardware component for processing data may include a central processing unit (CPU), a graphics processing unit (GPU), a digital signal processing unit (DSP), a microcontroller (MCU), and/or a natural processing unit (NPU). The number of processors 201 may be one or more. For example, the processor 201 may have a structure of a multi-core processor such as a dual core, a quad core, or a hexa core. The processor 201 of FIG. 2 may be applied in substantially the same manner as the processor 120 of FIG. 1.

For example, the processor 201 may include various processing circuits and/or multiple processors. For example, the term “processor” used in this document, including claims, may include various processing circuits including at least one processor, and one or more of the at least one processor may be configured to perform various functions described below individually and/or collectively in a distributed manner. As used below, when “a processor”, “at least one processor”, and “one or more processors” are described as being configured to perform various functions, these terms are not limited thereto, and also encompass, for example, situations in which one processor performs some of the cited functions and another processor(s) performs another some of the cited functions, and situations in which one processor may perform all of the cited functions. Additionally, the at least one processor may include a combination of processors that perform the various functions enumerated/disclosed, for example, in a distributed manner. The at least one processor may execute program instructions to achieve or perform various functions.

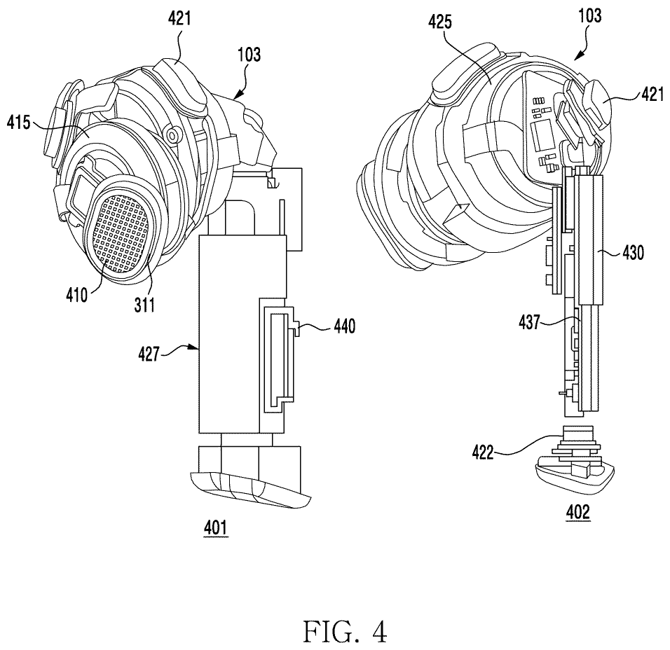

According to an embodiment, the wearable device 103 may include a plurality of microphones 203 for acquiring sound (e.g., voice, noise, audio) input from the outside of the wearable device 103. As a non-limiting example, the plurality of microphones 203 may include an inner microphone (e.g., the inner microphone 410 of FIG. 4) and an outer microphone (e.g., the first outer microphone 421 and the second outer microphone 422 of FIG. 4). As a non-limiting example, the inner microphone may include at least one microphone for acquiring sound (or sound data) from a first direction toward a user's body part, when the wearable device 103 is worn on the body part. As an example, the outer microphone may include at least one microphone for acquiring the sound (or sound data) from a second direction different from the first direction, while the wearable device 103 is worn on the body part. Alternatively, the inner microphone may be positioned toward the inside of the space formed by the body part and the wearable device 103, when the wearable device 103 is worn on the body part. In this case, when the wearable device 103 is worn on the body part, the outer microphone may be positioned toward the outside of the space formed by the body part and the wearable device 103. As a non-limiting example, the outer microphone may include a main microphone and an auxiliary microphone for obtaining the sound from the second direction. The details related thereto will be illustrated and described below with reference to FIG. 4.

For example, the microphone may be a digital microphone, an electronic condenser microphone (ECM), a micro electromechanical system (MEMS), or the like, but the disclosure is not limited thereto. The details of the microphone of FIG. 2 may be substantially the same as the those of the input module 150 of FIG. 1.

According to an embodiment, the wearable device 103 may include a speaker 205 for outputting sound information (e.g., sound or sound data). For example, the wearable device 103 may include a nozzle used as a path for the sound information output from the speaker 205. For example, the nozzle may be referred to as an acoustic port. For example, the nozzle may be a path through which the wearable device 103 is supported in the body part and sound output from the wearable device 103 passes, when the wearable device 103 is worn on the body part. For example, the nozzle may be connected to an ear tip. For example, the ear tip may represent a member in contact with the body part. While FIG. 2 illustrates the wearable device 103 including the speaker 205 that outputs sound information, the embodiment of the disclosure is not limited thereto. For example, the wearable device 103 may include an actuator (or motor) for providing haptic feedback based on vibration.

According to an embodiment, the communication circuit 207 of the wearable device 103 may include hardware for supporting transmission and/or reception of an electrical signal between the wearable device 103 and the electronic device 101. The communication circuit 207 may include, for example, at least one of a modem (MODEM), an antenna, and an optical/electronic (O/E) converter. The communication circuit 207 may support transmission and/or reception of an electrical signal, based on various types of communication schemes such as Ethernet, Bluetooth, Bluetooth low energy (BLE), ZigBee, Long term Evolution (LTE), or 5G new radio (NR). Details of the communication circuit 207 of FIG. 2 may be applied substantially the same as the communication module 190 and/or the antenna module 197 of FIG. 1.

According to an embodiment, the wearable device 103 may include memory 209. The memory 209 may include a hardware component for storing data and/or instructions inputted to or outputted from the processor 201. The memory 209 may include, for example, a volatile memory such as a random-access memory (RAM), and/or a non-volatile memory such as a read-only memory (ROM). The volatile memory may include, for example, at least one of dynamic RAM (DRAM), static RAM (SRAM), cache RAM, or pseudo SRAM (PSRAM). The non-volatile memory may include, for example, at least one of programmable ROM (PROM), electrically erasable PROM (EEPROM, flash memory, hard disk, compact disk, or embedded multimedia card (eMMC). As for the detailed content of the memory 209 of FIG. 2, the content of the memory 130 of FIG. 1 may be applied substantially the same.

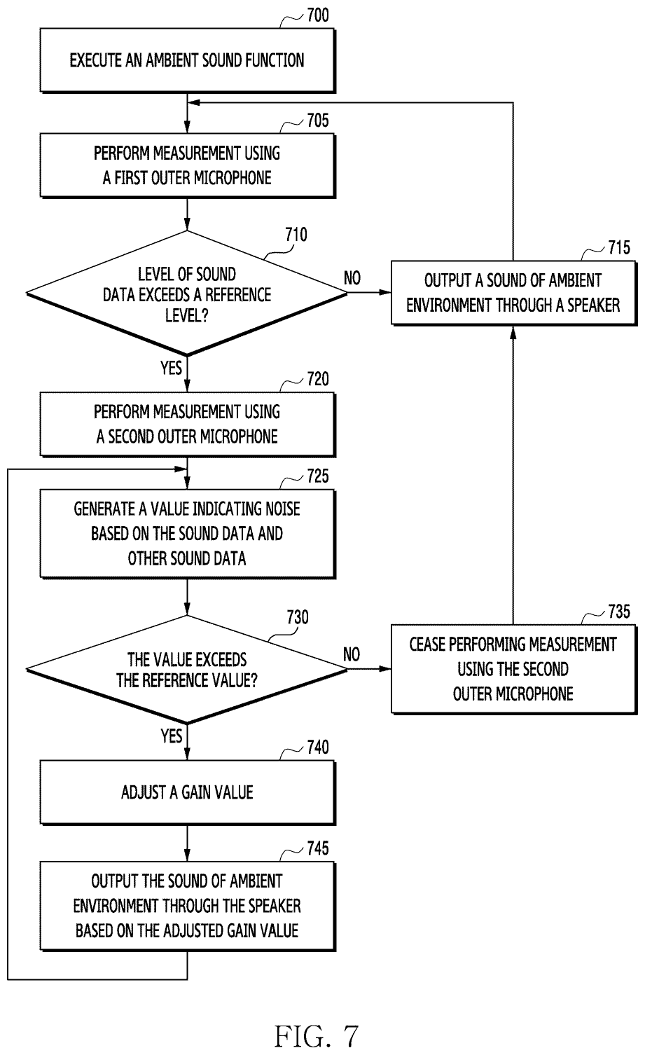

According to an embodiment, in the memory 209 of the wearable device 103 may be stored one or more instructions (or instructions) indicating arithmetic operations and/or actions to be performed on data by the processor 201 of the wearable device 103. A set of one or more instructions may be referred to as a program, firmware, an operating system, a process, a routine, a sub-routine, and/or an application. In the following, when an application is installed in the electronic device (e.g., the wearable device 103), as one or more instructions provided in the form of an application being stored in the memory 209, it may mean that the one or more applications are stored in an executable format (e.g., a file having an extension designated by the operating system of the wearable device 103) that can be executed by the processor of the electronic device. According to an embodiment, the wearable device 103 may perform an operation of FIG. 7 by executing one or more instructions stored in the memory 209. For example, the one or more instructions, when executed by the processor 201, may cause the wearable device 103 to perform at least some of the operations of FIG. 7.

Although not shown in FIG. 2, the wearable device 103 may include at least one sensor. As a non-limiting example, the wearable device 103 may include a proximity sensor. For example, the proximity sensor may be referred to as a sensor, a sensor circuit, a proximity sensor module, or a sensor module. As a non-limiting example, the wearable device 103 may include a touch sensor module for identifying an input to the wearable device 103. For example, the touch sensor module may include at least one of a force sensor or a touch sensor for identifying the input (or a touch input) for the wearable device 103. According to an embodiment, the wearable device 103 may further include an acceleration sensor for identifying a movement of the wearable device 103. As a non-limiting example, the wearable device 103 may further include a barometer for measuring an external air pressure of the wearable device 103, a heart rate monitor (HRM) for measuring one's pulse, an electrocardiogram (ECG), or a bioelectrical impedance analysis (BIA). As a non-limiting example, the wearable device 103 may include a hall sensor or an integrated circuit (IC) for processing data obtained from the hall sensor.

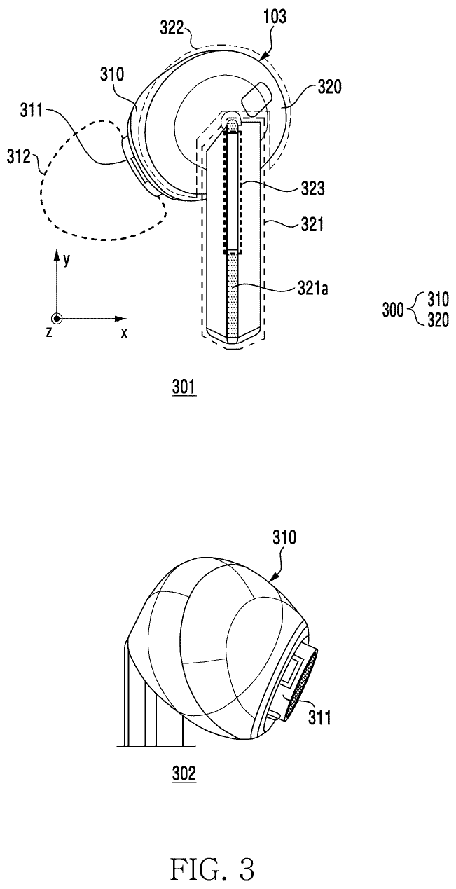

Although not shown in FIG. 2, the wearable device 103 may include a light emitter (e.g., an emitter 323 of FIG. 3). For example, the emitter may emit visible light, unlike the proximity sensor of the at least one sensor. For example, the emitter may be used to provide a notification to a user by means of light emission. For example, the emitter may be referred to as a light emitting diode (LED), an indicator or a blade light.

Although not shown in FIG. 2, according to an embodiment, the wearable device 103 may include a module for supplying power. For example, the wearable device 103 may include a battery. Details of the battery may be substantially the same as those of the battery 189 of FIG. 1.

As described above, the details of the structure of the wearable device 103 are illustrated and described below with reference to FIGS. 3 to 5.

FIG. 3 illustrates an example of a housing of a wearable device according to an embodiment of the disclosure.

FIG. 3 illustrates an example of the wearable device 103 of FIG. 2. For example, FIG. 3 illustrates an example 301 showing at least a part of the housing 300 of the wearable device 103 as shown when the wearable device 103 of FIG. 2 is viewed from a first direction (e.g., +z direction). Further, for example, FIG. 3 illustrates an example 302 showing at least a part of the housing 300 of the wearable device 103 as shown when the wearable device 103 of FIG. 2 is viewed from a second direction (e.g., −z direction) opposite to the first direction.

For example, the wearable device 103 may include the housing 300 that forms the exterior of the wearable device 103. For example, the housing 300 may include a first housing portion 310 and a second housing portion 320. For example, the first housing portion 310 may include a portion to be worn on a user's body part when the wearable device 103 is worn on the user's body part (e.g., an ear portion or an ear canal portion). For example, the second housing portion 320 may include a portion fastened to the first housing portion 310 and extending from the first housing portion 310. For example, the first housing portion 310 may be referred to as a first case or a rear housing. For example, the second housing portion 320 may be referred to as a second case or a front housing.

Referring to the example 301, the wearable device 103 may include a nozzle 311 included in the first housing portion 310. For example, the nozzle 311 may be used as a path for sound information output from a speaker (e.g., the speaker 205 of FIG. 2) included in the housing of the wearable device 103 and may indicate a part coming into contact with the user's body part (or a part connected to the contacting ear tip 312). For example, the ear tip 312 connected (or fastened) to the nozzle 311 may contact the user's body part. The ear tip 312 may be formed of a material (or an elastic member) having elasticity so as to come into close contact with the user's body part, when the wearable device 103 is worn on the user's body part.

Although not shown in FIG. 3, the first housing portion 310 may include an inner microphone (e.g., the inner microphone 410 of FIG. 4) of a plurality of microphones 203 of FIG. 2. Further, the first housing portion 310 may include a speaker (e.g., the speaker 415 of FIG. 4) for outputting sound information. The speaker may be an example of the speaker 205 of FIG. 2.

For example, the second housing portion 320 fastened to the first housing portion 310 may include a stem portion 321 and a head portion 322. Although not shown in FIG. 3, a part of the head portion 322 may include a first outer microphone (or sub-microphone) (e.g., the first outer microphone 421 of FIG. 4) among the plurality of microphones 203 of FIG. 2.

For example, the stem portion 321 may include at least a part of the second housing portion 320. For example, the stem portion 321 may include a portion extending along a specific direction (e.g., y-axis direction) from the head portion 322 of the second housing portion 320. For example, at least one sensor (e.g., force sensor, touch sensor) may be included in the stem portion 321. Accordingly, the wearable device 103 may identify (or obtain or recognize) a user's touch input to the stem portion 321.

For example, the stem portion 321 may include a periphery 321a. For example, the periphery 321a of the stem portion 321 may be formed on the exterior of the wearable device 103 along the specific direction (e.g., y-axis direction). As a non-limiting example, the periphery 321a may be a protruding portion from the exterior of the wearable device 103. For example, the wearable device 103 may include a light emitter 323 at least partially positioned along the edge 321a of the stem portion 321. Although not shown in FIG. 3, one end (e.g., one end in −y-axis direction) of the stem portion 321 may include a second outer microphone (or main microphone) (e.g., the second outer microphone 422 of FIG. 4) among a plurality of microphones 203.

Referring to the example, the first housing portion 310 may be formed in a structure adapted for being seated on the user's body part, when worn on the user's body part. For example, the first housing portion 310 may be supported by the user's body part.

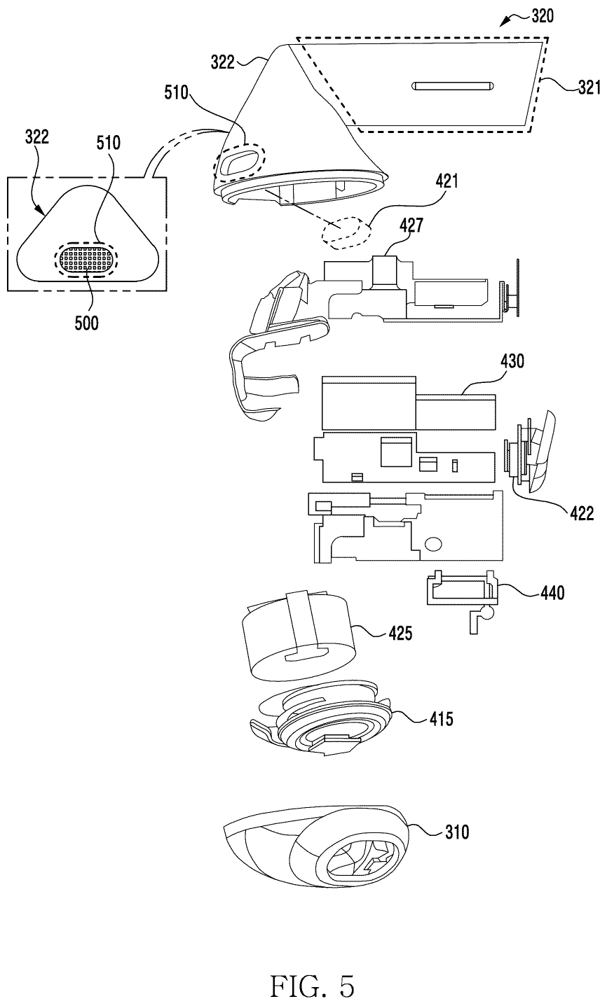

Referring to FIG. 3, a structure viewed from the outside of the housing 300 of the wearable device 103 is illustrated. Details of the internal structure of the housing 300 may be described with reference to FIGS. 4 and 5 below.

FIGS. 4 and 5 illustrate examples of an exploded perspective view of a wearable device according to various embodiments of the disclosure.

FIG. 4 illustrates examples of an exploded perspective view of the interior of the housing 300 of the wearable device 103.

Referring to an example 401 of FIG. 4, the wearable device 103 may include a nozzle 311, an inner microphone 410, and a speaker 415 within an inner space of the housing 300 corresponding to the first housing portion 310. As a non-limiting example, the inner microphone 410 may be located in a space inside the nozzle 311. For example, the nozzle 311 may be used as a grill structure of the inner microphone 410. The grill structure may be referred to as a wind grill. For example, the grill structure may be used so that the inner microphone 410 has robust performance against noise (e.g., bursting sound) among sounds acquired (or introduced) from the outside of the wearable device 103. As a non-limiting example, the nozzle 311 may surround the inner microphone 410. For example, the inner microphone 410 may be positioned (or disposed) toward a body part of the user when the wearable device 103 is worn on the body part (e.g., an ear portion). For example, the inner microphone 410 may be an example of the plurality of microphones 203 of FIG. 2. For example, the speaker 415 may at least partially contact the nozzle 311 (and/or the inner microphone 410). For example, the speaker 415 may be an example of the speaker 205 of FIG. 2.

Referring to the example 401 of FIG. 4, the wearable device 103 may include a first outer microphone 421 in the inner space of the housing 300 corresponding to the head portion 322 of the second housing portion 320. Although not shown in FIG. 4, the head portion 322 of the second housing portion 320 may include a grill structure for at least partially covering the first outer microphone 421 from the outside of the wearable device 103. A specific example of the grill structure may be referenced to FIG. 5. For example, the first outer microphone 421 may be an example of the plurality of microphones 203 of FIG. 2.

Referring to the example 401 of FIG. 4, the wearable device 103 may include a flexible printed circuit board (FPCB) 427 in the inner space of the housing 300 corresponding to the stem portion 321 of the second housing portion 320. For example, the FPCB 427 may be used for electrical connection and support of other components located in the inner space of the housing 300 corresponding to the stem portion 321 of the second housing portion 320. As a non-limiting example, the FPCB 427 may be electrically connected to each of a touch sensor (or touch pad), a touch IC (integrated circuitry), a system in package (SIP) 430, and an antenna structure 440. For example, the touch sensor (or touch pad), the touch IC (integrated circuitry), and the antenna structure 440 may be disposed on the FPCB 427.

Referring to an example 402 of FIG. 4, the wearable device 103 may include a battery 425 in the inner space of the housing 300 corresponding to the head portion 322 of the second housing portion 320. Although not shown in FIG. 4, the wearable device 103 may include a circuit for managing the battery 425. For example, the circuit may include power management integrated circuitry (PMIC). For example, the PMIC may be electrically connected to the processor 201 of the wearable device 103.

Referring to the example 402 of FIG. 4, the wearable device 103 may include a PCB 437 (or a main PCB) and a SIP 430 within the inner space of the housing 300 corresponding to the stem portion 321 of the second housing portion 320. For example, the SIP 430 may be disposed on one surface of the PCB 437. As a non-limiting example, the SIP 430 may include the processor 201 of FIG. 2. As a non-limiting example, the SIP 430 may include the memory 209 of FIG. 2. As a non-limiting example, the SIP 430 may include the communication circuit 207 of FIG. 2. For example, the PCB 437 may be electrically connected to the FPCB 427. For example, the processor 201 or memory 209 in the SIP 430 may store a trained model. For example, the trained model may be referred to as an artificial intelligence (AI) model, an AI module, an AI engine, or a deep natural network (DNN).

In the above example, it is described that the SIP 430 is disposed on the one side of the PCB 437, but the disclosure is not limited thereto. For example, other components may be further disposed on the PCB 437.

Referring to the example 402 of FIG. 4, the wearable device 103 may include a second outer microphone 422 within the inner space of the housing 300 corresponding to the stem portion 321 of the second housing portion 320. For example, the second outer microphone 422 may be an example of the plurality of microphones 203 of FIG. 2. As a non-limiting example, the second outer microphone 422 may be located at one end of the stem portion 321. Although not shown in FIG. 4, the second outer microphone 422 may be located in an area corresponding to a hole (or a recess or opening) included in the housing 300 (or the second housing portion 320 or the stem portion 321). As a non-limiting example, the second outer microphone 422 may acquire (or receive or measure) sound (or sound data) through the hole.

FIG. 5 illustrates an example of an exploded perspective view of the wearable device 103 when viewed from a side direction of the wearable device 103 of FIG. 4.

Referring to FIG. 5, the wearable device 103 may include a housing 300 including a first housing portion 310 and a second housing portion 320. As a non-limiting example, the inner space of the housing 300 may include a speaker 415, a battery 425, an antenna structure 440, a SIP 430, and an FPCB 427. In FIG. 5, some of the components of the wearable device 103 shown in FIG. 4 are illustrated, but the disclosure is not limited thereto.

Referring to FIG. 5, the first outer microphone 421 may be positioned between the speaker 415 and the battery 425 in the inner space of the housing 300. As a non-limiting example, at least a portion of the first outer microphone 421 may be visually exposed from the outside of the wearable device 103 through a partial area of the head portion 322 of the second housing portion 320. For example, the second housing portion 320 (or the head portion 322 of the second housing portion 320) may include a grill structure 500 for at least partially covering the first outer microphone 421 from the outside of the wearable device 103 in an area 510. As a non-limiting example, the grill structure 500 may surround the first outer microphone 421. For example, the grill structure 500 may be used to have robust performance against noise (e.g., bursting sound) among sounds acquired by the first outer microphone 421 from the outside of the wearable device 103. The grill structure 500 may be referred to as a wind grill.

Referring to FIG. 5, the second outer microphone 422 may be located in the inner space of the housing 300 corresponding to one end of the second housing portion 320 (or one end of the stem portion 321). As described above, the one end of the second housing portion 320 may include a hole, which serves as a path for the second outer microphone 422 to acquire sound from the outside of the wearable device 103. In other words, unlike the inner microphone 410 and the first outer microphone 420, the grill structure is not used in the second outer microphone 422, and thus the noise of sound acquired by the second outer microphone 422 from the outside of the wearable device 103 may be relatively strong.

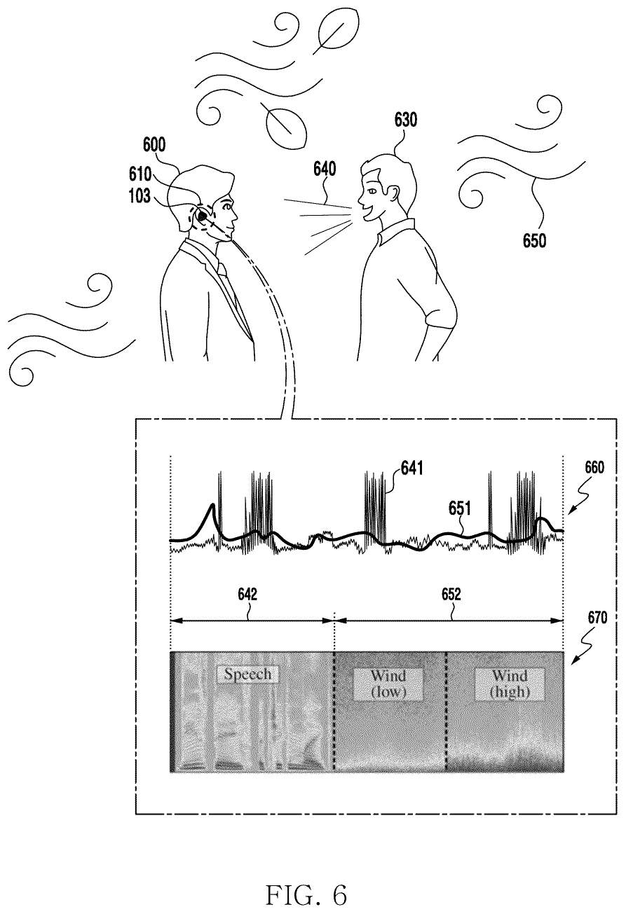

FIG. 6 illustrates an example of sound data of a user's ambient environment acquired by a wearable device when an ambient sound function is executed according to an embodiment of the disclosure.

FIG. 6 illustrates an example in which the wearable device 103 acquires sound data of an ambient environment of a user 600, while the wearable device 103 is worn by the user 600. For example, the wearable device 103 may be worn (or supported or positioned) on an ear portion 610 of the user 600. In the example of FIG. 6, it is assumed that the wearable device 103 executes an ambient sound function.

Referring to FIG. 6, the user 600 wearing the wearable device 103 may communicate with another user 630. For example, while listening to sound information (e.g., music) through the wearable device 103, the user 600 may encounter another user 630 and control the wearable device 103 to execute the ambient sound function. Although not shown in FIG. 6, the sound information may be obtained from a parent terminal (e.g., the electronic device 101 of FIG. 1) connected to the wearable device 103.

As the ambient sound function is executed, the wearable device 103 may measure a sound of the ambient environment using a plurality of microphones 203 (or the first outer microphone 421 and the second outer microphone 422 among the microphones 203) of the wearable device 103. For example, the sound may include a speech 640 uttered by another user 630 and a noise 650 caused by wind.

Referring to FIG. 6, an example of a chart 660 showing waveforms for a voice 640 and a noise 650 obtained by the wearable device 103 is illustrated. For example, a waveform 641 may represent the voice 640, and a waveform 651 may represent the noise 650. Each of the waveform 641 and the waveform 651 is illustrated as an analog waveform for convenience of description, but the disclosure is not limited thereto. As a non-limiting example, the sound data acquired by the wearable device 103 using the microphones 203 may be digital data. Referring to the chart 660, the sound data acquired by the wearable device 103 may include the voice 640 and the noise 650. When outputting the sound data as it is, according to the ambient sound function, the user 600 of the wearable device 103 may hear the noise 650 that does not want to hear as well as the voice 640 that wants to hear. Accordingly, the wearable device 103 may perform a process for removing (or suppressing) the noise 650 in the sound data in order to provide a higher quality of function. For the description of the processing, a chart 670 indicating the energy of the voice 640 and the noise 650 according to the frequency band may be referenced.

The chart 670 may include a part 642 for a characteristic indicating energy according to the frequency band of the voice 640 and a part 652 for a characteristic indicating energy according to the frequency band of the noise 650. For example, the part 652 illustrates both a relatively weak case (left) and a relatively strong case (right) of the wind causing the noise 650. Referring to the part 642, the energy of the voice 640 may be relatively evenly distributed over the entire frequency band. In contrast, referring to the part 652, regardless of the intensity of the wind causing the noise 650, the energy of the noise 650 may be concentrated and distributed in a relatively low frequency band of the frequency band.

The wearable device 103 may provide (or output) the sound to the user 600 through the speaker 205 of the wearable device 103 based on sound data obtained according to the measurement performed using the microphones 203. As a non-limiting example, the wearable device 103 may use filtering (e.g., high pass filter (HPF)) or correlation as a process for removing (or suppressing) the noise 650 of the sound data obtained according to the measurement performed using the microphones 203. Hereinafter, in the disclosure, description is made of the case of using the correlation, but the disclosure is not limited thereto. For example, the correlation may include removing the noise 650 by analyzing a correlation between sound data obtained through each of the plurality of microphones 203 (or the first outer microphone 421 and the second outer microphone 422). For example, the wearable device 103 may output the sound data (or sound or sound information) in which the noise 650 is removed among the sound data, through the speaker 205.

Hereinafter, in the disclosure, as described above, when an ambient sound function is executed, the wearable device 103 may control the operation of the plurality of microphones 203 (or the first outer microphone 421 and the second outer microphone 422). Accordingly, the disclosure may effectively provide the user 600 with the ambient sound function to depending on the noise 650 of the ambient environment while reducing power consumption (or current used in the microphone) of the wearable device 103.

FIG. 7 illustrates an example of an operation flow for a method of controlling outer microphones that measure sound data according to execution of an ambient sound function according to an embodiment of the disclosure.

At least a portion of the method of FIG. 7 may be performed by the wearable device 103 of FIG. 2. For example, at least a portion of the method may be controlled by the processor 201 of the wearable device 103. In the following embodiment, each operation may be performed sequentially, but it is not necessarily performed sequentially. For example, the order of each operation may be changed, and at least two operations may be performed in parallel.

Although not shown in FIG. 7, the wearable device 103 may be worn on a user's body part (e.g., an ear portion). For example, the wearable device 103 may detect that it is worn on the user's body part and output a signal notifying that it is worn on the user's body part, through the speaker 205.

In operation 700, the wearable device 103 may execute an ambient sound function. As a non-limiting example, the wearable device 103 may execute the ambient sound function according to a command received from the electronic device 101 connected to the wearable device 103. As a non-limiting example, the wearable device 103 may execute the ambient sound function by receiving an input related to the wearable device 103.

Although not shown in FIG. 7, in an example, the wearable device 103 may execute an ANC function before executing the ambient sound function. For example, the wearable device 103 may execute the ambient sound function while executing the ANC function. However, the disclosure is not limited thereto. As described above, regardless of the execution of the ANC function, the wearable device 103 may execute the ambient sound function.

In operation 705, the wearable device 103 may perform a measurement using the first outer microphone 421. For example, the wearable device 103 may perform a measurement of a sound of the user's ambient environment using the first outer microphone 421 based on executing the ambient sound function. Further, the wearable device 103 may refrain from measuring the sound of the user's ambient environment using the second outer microphone 422, based on executing the ambient sound function. The wearable device 103 may reduce power consumption (or current consumption) by performing a measurement using the first outer microphone 421 of a plurality of microphones 203 (or outer microphones) and not performing a measurement using the second outer microphone 422. In addition, as the measurement is not performed using the second outer microphone 422, the performance degradation (e.g., howling) that may be caused by covering the second outer microphone 422 may be reduced (or prevented).

In the disclosure, it is illustrated that wearable device 103 includes multiple microphones 203 inclusive of three microphones, but the disclosure is not limited. For example, wearable device 103 may include four or more microphones. Further, for example, the wearable device 103 may include three or more outer microphones among four or more microphones. The operations described in the disclosure may be applied substantially the same for a case of three or more outer microphones.

In the above example, while both the first outer microphone 421 and the second outer microphone 422 are active, it is described that the first outer microphone 421 is used for measurement while the second outer microphone 422 is not used for measurement, but the disclosure is not limited thereto.

As a non-limiting example, the wearable device 103 may provide power to the first outer microphone 421 to perform the measurement using the first outer microphone 421. In other words, the wearable device 103 may activate (or turn on) the first outer microphone 421 by providing power to the first outer microphone 421. The wearable device 103 may perform a measurement of a sound of the ambient environment using the activated first outer microphone 421.

As a non-limiting example, the wearable device 103 may cease (or block) providing power to the second outer microphone 422 in order to refrain from performing the measurement using the second outer microphone 422. In other words, the wearable device 103 may deactivate (or turn off) the second outer microphone 422 by ceasing providing power to the second outer microphone 422. The wearable device 103 may not perform the measurement of the sound of the ambient environment, using the deactivated second outer microphone 422.

In operation 710, the wearable device 103 may determine whether a level of sound data exceeds a reference level. For example, the wearable device 103 may acquire the sound data according to the measurement performed using the first outer microphone 421. For example, the wearable device 103 may determine whether the level (or size) of the sound data exceeds the reference level (or reference size).

For example, the reference level may be defined as a representative value for a frequency band (e.g., 200 Hz to 1200 Hz) of the received sound data (or sound data related to noise in the ambient environment). For example, the representative value may include a mean value, an intermediate value, or a result of a similar operation thereto.

In operation 710, the wearable device 103 may perform operation 715 as it determines that the level of the sound data acquired according to the measurement performed using the first outer microphone 421 is less than or equal to the reference level. In contrast, in operation 710, the wearable device 103 may perform operation 720 as it determines that the level of the sound data acquired according to the measurement performed using the first outer microphone 421 exceeds the reference level.

In operation 715, the wearable device 103 may output the sound of the ambient environment through the speaker 205. For example, the wearable device 103 may output the sound of the ambient environment through the speaker 205, based on the sound data acquired through the first outer microphone 421. The wearable device 103 may recognize that the sound level (or the noise level of the sounds) is low since the level is less than or equal to the reference level.

As a non-limiting example, the wearable device 103 may output the acquired sound data through the speaker 205 without processing the acquired sound data. As a non-limiting example, the wearable device 103 may output the sound through the speaker 205 by amplifying the sound data without processing of removing the noise from the acquired sound data. For example, the amplification may use a gain value applied to the sound data. For example, the gain value may be a first gain value. For example, the gain value may be referred to as a default gain value.

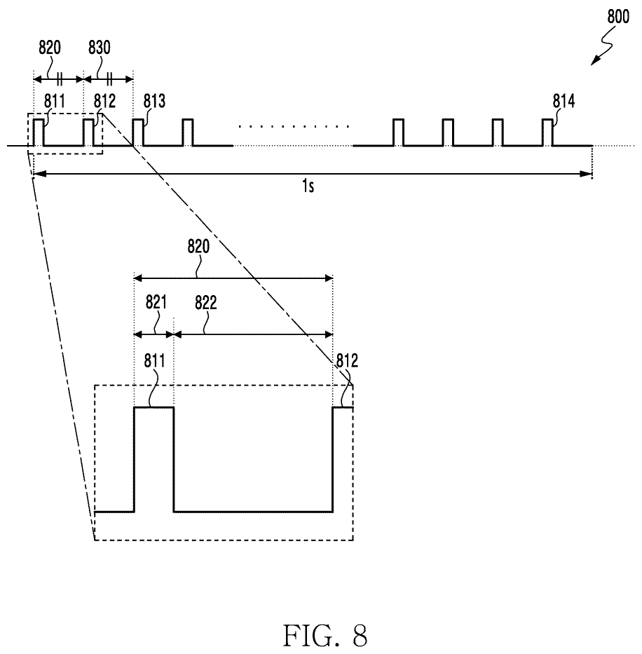

In operation 715, the wearable device 103 may output the sound of the ambient environment through the speaker 205 and then perform the operation 705 again. For example, the wearable device 103 may perform the measurement of the sound of the ambient environment using the first outer microphone 421. As a non-limiting example, the wearable device 103 may periodically measure the sound of the ambient environment using the first outer microphone 421. Details related thereto may be referenced to FIG. 8 below.

In operation 720, the wearable device 103 may perform a measurement using the second outer microphone 422. For example, based on executing the ambient sound function, the wearable device 103 may perform the measurement of the sound of the user's ambient environment using the second outer microphone 422. For example, the wearable device 103 may further perform the measurement using the second outer microphone 422 while performing the measurement using the first outer microphone 421. For example, the wearable device 103 may perform the measurement using the second outer microphone 422 while ceasing to perform the measurement using the first outer microphone 421.

As a non-limiting example, the wearable device 103 may provide power to the deactivated second outer microphone 422 to perform the measurement using the second outer microphone 422. In other words, the wearable device 103 may activate (or turn on) the second outer microphone 422 by providing power to the second outer microphone 422. The wearable device 103 may measure the sound of the ambient environment using the activated second outer microphone 422.

In operation 725, the wearable device 103 may generate a value indicating noise based on sound data and other sound data. For example, the wearable device 103 may generate a value indicating noise, based on the sound data obtained according to the measurement performed using the first outer microphone 421 and the other sound data obtained according to the measurement performed using the second outer microphone 422. For example, the wearable device 103 may generate the value indicating the noise by performing correlation between the sound data and the other sound data.

In operation 730, the wearable device 103 may determine whether the value exceeds a reference value. For example, the reference value may be used as a reference for identifying the noise level of the ambient environment by the value indicating the noise. In the above example, one reference value is described as an example, but the disclosure is not limited thereto. For example, a plurality of reference values may be used.

In the operation 730, the wearable device 103 may perform operation 735 as it determines that the value is less than or equal to the reference value. In the operation 730, the wearable device 103 may perform operation 740 as it determines that the value exceeds the reference value.

In operation 735, the wearable device 103 may cease performing the measurement using the second outer microphone 422. For example, as the wearable device 103 determines that the value is less than or equal to the reference value, the wearable device 103 may cease performing the measurement using the second outer microphone 422 again. This may be because there is relatively little noise in the sound of the ambient environment when the value is less than or equal to the reference value. Accordingly, the wearable device 103 may not perform the measurement using the second outer microphone 422.

After performing the operation 735, the wearable device 103 may perform operation 715 and operation 705 again. For specific information related thereto, the operation 715 and the operation 705 may be referenced. Alternatively, as a non-limiting example, after performing the operation 735, the wearable device 103 may output the sound of the ambient environment through the speaker 205, based on the sound data obtained according to the measurement performed using the first outer microphone 421 and the other sound data obtained according to the measurement performed using the second outer microphone 422. For example, the output sound may represent the sound data, the other sound data, and sound information processed by the first gain value.

In operation 740, the wearable device 103 may adjust the gain value. For example, as it determines that the value exceeds the reference value, the wearable device 103 may adjust the gain value used to process the sound data and the other sound data. As a non-limiting example, the gain value may be adjusted from the first gain value to a second gain value different from the first gain value.

For example, the adjusted second gain value may vary according to a degree of the noise being included in the sound of the ambient environment. For example, when the value exceeds the other reference value exceeding the reference value, the size of the second gain value may be identified as a first size. For example, when the value exceeds the reference value and is less than or equal to the other reference value, the size of the second gain value may be identified as a second size different from the first size. As in the above example, in operation 730, the wearable device 103 may perform a comparison between the value and a plurality of reference values rather than performing a comparison between the value and one reference value.

Further, instead of performing a comparison between the value and the reference values, the wearable device 103 may perform a comparison between the value and the reference ranges. For example, the wearable device 103 may determine whether the value falls within a first reference range of the reference ranges or a second reference range of the reference ranges. Accordingly, the wearable device 103 may perform the operation 735 as it determines that the value is included in the first reference range of the reference ranges, and may perform the operation 740 as it determines that the value is included in the second reference range of the reference ranges. Alternatively, for example, assuming that the reference ranges include 10 reference ranges, the wearable device 103 may perform the operation 735 when the value is included in the lower 3 reference ranges of the 10 reference ranges, and the wearable device 103 may perform the operation 740 as it is determined that the value is included in the upper 7 reference ranges of the 10 reference ranges. In the above example, the size of the second gain value may be adjusted according to the order of the reference range in which the value is included.

In operation 745, the wearable device 103 may output the sound of the ambient environment through the speaker 205 based on the adjusted gain value. For example, the wearable device 103 may generate the sound of the ambient environment to be output by processing the sound data and the other sound data based on the second gain value. For example, the wearable device 103 may output the sound through the speaker 205. In operation 745, the sound output through the speaker 205 may be a noise-removed (or suppressed) sound compared to the sound data (or sound) acquired through the plurality of microphones 203.

After performing the operation 745, the wearable device 103 may perform the operation 725 again. For example, the wearable device 103 may periodically acquire sound data using each of the first outer microphone 421 and the second outer microphone 422, and accordingly, provide the ambient sound listening function.

Referring to the foregoing description, the wearable device 103 according to the disclosure may dynamically control the operation of the plurality of microphones 203 in the wearable device 103 according to the sound volume (or noise volume) of the external environment. Accordingly, the wearable device 103 may reduce the power consumption (or current consumption) of the wearable device 103 and prevent unnecessary use of the resource. In other words, the usage time of the wearable device 103 may be increased.

FIG. 8 illustrates an example of a time period for measuring a sound of an ambient environment through an outer microphone according to an embodiment of the disclosure.

FIG. 8 illustrates an example 800 representing a circumstance where each of the measurement performed using the first outer microphone 421 in operation 705 of FIG. 7 (hereinafter, referred to as the first measurement) and the measurement performed using the second outer microphone 422 in operation 720 of FIG. 7 (hereinafter, referred to as the second measurement) is periodically performed. In the example 800 of FIG. 8, it is assumed that both the first measurement and the second measurement are performed periodically according to the same period, but the disclosure is not limited thereto. For example, the first measurement may be performed periodically according to a first period, and the second measurement may be performed periodically according to a second period different from the first period. Alternatively, for example, the first measurement may be performed periodically, and the second measurement may be performed aperiodically. Alternatively, for example, the first measurement may be performed aperiodically, and the first measurement may be performed periodically.

Referring to the example 800, the wearable device 103 may acquire sound data 811, sound data 812, sound data 813, and sound data 814 within a specified time (e.g., 1 second) through measurements using a microphone (e.g., the first measurement or the second measurement). For example, the sound data 811 may be sound data acquired for the first time of the specified time. For example, the sound data 812 may be sound data acquired after the sound data 811. For example, the sound data 814 may be sound data acquired last of the specified time. For example, when the specified time is 1 second, the number of sound data 811, sound data 812, sound data 813, and sound data 814 may indicate a frequency of the measurement (or periodic measurement).

For example, a time period 820 between the time when the sound data 811 is acquired and the time when the sound data 812 is acquired may correspond to a time period 830 between the time when the sound data 812 is acquired and the time when the sound data 813 is acquired. For example, a length of the time period 820 (or a length of the time period 830) may be referred to as a period of the measurement (or periodic measurement).

For example, within the time period 820 according to the period, the wearable device 103 may perform measurement of the sound of the ambient environment using a microphone to acquire the sound data 811 during the first time period 821. Further, within the time period 820 according to the period, the wearable device 103 may refrain (or cease) from performing measurement for acquiring sound data using a microphone during the second time period 822. In the example 800 of FIG. 8, the first time period 821 is illustrated as shorter than the second time period 822, but this is only an example for convenience of explanation, and the disclosure is not limited thereto. Alternatively, the wearable device 103 may continuously perform the measurement. In this case, a length of the first time period 821 may correspond to a length of the time period 820.

As a non-limiting example, a period of the first measurement may be synchronized with a period of the second measurement. For example, the second measurement may be performed within a time period in which the first measurement is performed. In this case, noise may be more effectively removed owing to using sound data acquired at the same time.

Referring to FIGS. 1 to 8, when the ambient sound function is executed, the wearable device of the disclosure may measure the sound (or sound data) of the ambient environment using some of a plurality of microphones of the wearable device, and refrain from measuring the sound (or sound data) of the ambient environment using the remaining microphones. The wearable device of the disclosure may provide an ambient sound function based on sound data measured using some of the microphones, or determine an execution of measurement of sound (or sound data) using the remaining microphones, based on the sound data measured using the some of the microphones. In other words, the disclosure may provide the ambient sound function by controlling the operation of at least one of the plurality of microphones of the wearable device according to the sound (or noise in the sound) of the ambient environment. Accordingly, the disclosure can increase the usage time of the wearable device by reducing the battery consumption of the wearable device and decreasing resources used in the wearable device. Furthermore, the disclosure may smoothly provide the ambient sound function together with the increased usage time.

The effects that can be obtained from the disclosure are not limited to those mentioned above, and other effects not mentioned herein will be clearly understood by those having ordinary skill in the art to which the disclosure belongs from the present description.

As described above, a wearable device 103 being wearable by an ear portion of a user may include at least one processor 201 including processing circuitry. The wearable device 103 may include memory 209, storing one or more programs configured to be executed by the at least one processor 201 individually and/or collectively, including one or more storage media. The wearable device 103, when the wearable device 103 is worn by the ear portion, may include a plurality of microphones 203 including an inner microphone 410 positioned toward inside of a space formed by the wearable device 103 and the ear portion, and a first outer microphone 421 and a second outer microphone 422 each positioned toward outside of the space. The wearable device may include a speaker 205. The one or more programs may include instructions that cause the wearable device 103 to execute an ambient sound function. The one or more programs may include instructions that cause the wearable device 103 to, based on executing the ambient sound function, perform a measurement with respect to a sound of ambient environment of the user using the first outer microphone 421. The one or more programs may include instructions that cause the wearable device 103 to, based on executing the ambient sound function, refrain from performing a measurement with respect to a sound of the ambient environment of the user using the second outer microphone 422. The one or more programs may include instructions that cause the wearable device 103 to obtain sound data according to the measurement performed using the first outer microphone 421. The one or more programs may include instructions that cause the wearable device 103 to, in accordance with a level of the sound data less than or equal to a reference level for providing the ambient sound function, output, through the speaker, a sound of the ambient environment based on the sound data obtained using the first outer microphone 421. The one or more programs may include instructions that cause the wearable device to, in accordance with the level of the sound data greater than the reference level, perform the measurement with respect to a sound of ambient environment of the user using the second outer microphone 422.

According to an embodiment, the wearable device 103 may include a housing 300 including a first housing portion 310 to be worn by the ear portion of the user and a second housing portion 320 to be engaged with the first housing portion 310. The first housing portion 310 may include the speaker 205 and the inner microphone 410 among the plurality of microphones 203. The second housing portion 320 may include a head portion 322 including the first outer microphone 421 among the plurality of microphones 203. The second housing portion 320 may include a stem portion 321 including the second outer microphone 422 among the plurality of microphones 203 and extending from the head portion 322.

According to an embodiment, the head portion 322 of the second housing portion 320 may include a grill structure 500 to cover at least portion of the first outer microphone 421 from outside of the wearable device 103.

According to an embodiment, the first housing portion 310 may include a nozzle 311 used as a path of a sound outputted through the speaker 205. The first housing portion 310 may include an ear-tip 312 connected to the nozzle 311.

According to an embodiment, the one or more programs may include instructions that cause the wearable device 103 to obtain another sound data according to the measurement performed using the second outer microphone 422. The one or more programs may include instructions that cause the wearable device 103 to generate a value indicating a noise of the ambient environment based on the sound data and the other sound data. The one or more programs may include instructions that cause the wearable device 103 to, in accordance with the value less than or equal to a reference value, cease to perform the measurement with respect to a sound of the ambient environment of the user using the second outer microphone 422.

According to an embodiment, the one or more programs may include instructions that cause the wearable device 103 to, in accordance with the value less than or equal to the reference value, output, through the speaker 205, a sound of the ambient environment based on the sound data obtained using the first outer microphone 421.

According to an embodiment, the one or more programs may include instructions that cause the wearable device 103, in accordance with the value greater than the reference value, adjust a gain value for the ambient sound function according to the value from a first gain value to a second gain value. The one or more programs may include instructions that cause the wearable device 103 to output, through the speaker 205, a sound of the ambient environment based on the sound data obtained using the first outer microphone 421, the other sound data obtained using the second outer microphone 422, the second gain value.

According to an embodiment, one or more programs may include instructions that cause the wearable device 103 to, in accordance with the level of the sound data less than or equal to the reference level, output, through the speaker 205, a sound of the ambient environment based further on the first gain value.

According to an embodiment, the one or more programs may include instructions that cause the wearable device 103 to, in accordance with the value greater than another reference value greater than the reference value, identify a magnitude of the second gain value as a first magnitude. The one or more programs may include instructions that cause the wearable device 103 to, in accordance with the value less than or equal to the other reference value and greater than the reference value, identify the magnitude of the second gain value as a second magnitude different from the first magnitude.

According to an embodiment, the one or more programs may include instructions that cause the wearable device 103 to execute an active noise cancellation (ANC) function. The one or more programs may include instructions that cause the wearable device 103 to execute the ambient sound function, while executing the ANC function.

According to an embodiment, the one or more programs may include instructions that cause the wearable device 103 to perform the measurement with respect to a sound of the ambient environment of the user performed using the first outer microphone 421 according to a period. The one or more programs may include instructions that cause the wearable device 103 to perform the measurement with respect to a sound of the ambient environment of the user performed using the second microphone 422 according to the period.

According to an embodiment, the one or more programs may include instructions that cause the wearable device 103 to perform the measurement with respect to a sound of the ambient environment of the user performed using the first outer microphone 421 in a first time interval of a time duration according to the period. The one or more programs may include instructions that cause the wearable device 103 to cease to perform the measurement with respect to a sound of the ambient environment of the user performed using the first outer microphone 421 in a second time interval of the time duration according to the period.

According to an embodiment, the one or more programs may include instructions that cause the wearable device 103 to output, through the speaker 205, a sound of the ambient environment, by suppressing a noise from among a sound of the ambient environment based on the sound data obtained using the first outer microphone 421. The noise may be based on a wind of the ambient environment.

According to an embodiment, the one or more programs may include instructions that cause the wearable device 103 to, based on executing the ambient sound function, deactivate the second outer microphone 422 by ceasing to provide power to the second outer microphone 422.

As described above, a method performed by a wearable device 103 being wearable by an ear portion of a user, the wearable device including a plurality of microphones 203 including an inner microphone 410 positioned toward inside of a space formed by the wearable device 103 and the ear portion, and a first outer microphone 421 and a second outer microphone 422 each positioned toward outside of the space, and a speaker 205, when the wearable device is worn on the ear portion of the user, may comprise executing an ambient sound function. The method may comprise, based on executing the ambient sound function, performing a measurement with respect to a sound of ambient environment of the user using the first outer microphone 421. The method may comprise, based on executing the ambient sound function, refraining from performing a measurement with respect to a sound of the ambient environment of the user using the second outer microphone 422. The method may comprise obtaining sound data according to the measurement performed using the first outer microphone 421. The method may comprise, in accordance with a level of the sound data less than or equal to a reference level for providing the ambient sound function, outputting, through the speaker 205, a sound of the ambient environment based on the sound data obtained using the first outer microphone 421. The method may comprise, in accordance with the level of the sound data greater than the reference level, performing the measurement with respect to a sound of ambient environment of the user using the second outer microphone 422.

According to an embodiment, the wearable device 103 may include a housing 300 including a first housing portion 310 to be worn by the ear portion of the user and a second housing portion 320 to be engaged with the first housing portion 310. The first housing portion 310 may include the speaker 205 and the inner microphone 410 among the plurality of microphones 203. The second housing portion 320 may include a head portion 322 including the first outer microphone 421 among the plurality of microphones 203. The second housing portion 320 may include a stem portion 321, including the second outer microphone 422 among the plurality of microphones 203, extending from the head portion 322.

According to an embodiment, the head portion 322 of the second housing portion 320 may include a grill structure 500 to cover at least portion of the first outer microphone 421 from outside of the wearable device 103.

According to an embodiment, the method may include obtaining another sound data according to the measurement further performed using the second outer microphone 422. The method may include generating a value indicating a noise of the ambient environment based on the sound data and the other sound data. The method may include, in accordance with the value less than or equal to a reference value, ceasing to perform the measurement with respect to a sound of the ambient environment of the user using the second outer microphone 422.

According to an embodiment, the method may include, in accordance with the value greater than the reference value, adjusting a gain value for the ambient sound function according to the value from a first gain value to a second gain value. The method may include outputting, through the speaker 205, a sound of the ambient environment, based on the sound data obtained using the first outer microphone 421, the other sound data obtained using the second outer microphone 422, the second gain value.

As described above, one or more non-transitory computer-readable storage media may store one or more computer programs including instructions that, when executed by at least one processor 201 of a wearable device 103 individually or collectively, cause the wearable device 103 to execute an ambient sound function, when the wearable device 103 being wearable by an ear portion of a user is worn by the ear portion, the wearable device including a plurality of microphones 203 including an inner microphone 410 positioned toward inside of a space formed by the wearable device 103 and the ear portion, and a first outer microphone 421 and a second outer microphone 422 each positioned toward outside of the space, and a speaker 205. The non-transitory computer-readable storage media may store one or more computer programs including instructions that, when executed by the at least one processor 201 individually or collectively, cause the wearable device 103 to, based on executing the ambient sound function, perform a measurement with respect to a sound of ambient environment of the user using the first outer microphone 421. The non-transitory computer-readable storage media may store one or more computer programs including instructions that, when executed by the at least one processor 201 individually or collectively, cause the wearable device 103 to, based on executing the ambient sound function, refrain from performing a measurement with respect to a sound of the ambient environment of the user using the second outer microphone 422. The non-transitory computer-readable storage media may store one or more computer programs including instructions that, when executed by the at least one processor 201 individually or collectively, cause the wearable device 103 to obtain sound data according to the measurement performed using the first outer microphone 421. The non-transitory computer-readable storage media may store one or more computer programs including instructions that, when executed by the at least one processor 201 individually or collectively, cause the wearable device 103 to, in accordance with a level of the sound data less than or equal to a reference level for providing the ambient sound function, output, through the speaker 205, a sound of the ambient environment based on the sound data obtained using the first outer microphone 421. The non-transitory computer-readable storage media may store one or more computer programs including instructions that, when executed by the at least one processor 201 individually or collectively, cause the wearable device 103 to, in accordance with the level of the sound data greater than the reference level, perform the measurement with respect to a sound of ambient environment of the user using the second outer microphone 422.

The technical problems intended to be addressed in the disclosure are not limited to those mentioned above, and other technical problems not mentioned herein will be clearly understood by those having ordinary knowledge in the technical field to which the disclosure pertains.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. The electronic devices according to an embodiment of the disclosure are not limited to those described above.

It should be appreciated that various embodiments and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled to/with”, or “connected to/with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may be interchangeably used with other terms, for example, “logic,” “logic block,”, “part”, “portion” or “circuit”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., an internal memory 136 or an external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

No claim element is to be construed under the provisions of 35 U.S.C. § 112(f) or pre-AIA 35 U.S.C. § 112, sixth paragraph, unless the element is expressly recited using the phrase “means for” or “means”.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable device being wearable by an ear portion of a user, comprising:
at least one processor including processing circuitry;
memory, including one or more storage media, storing instructions;
a plurality of microphones including an inner microphone positioned toward inside of space formed by the wearable device and the ear portion when the wearable device is worn by the ear portion, and a first outer microphone and a second outer microphone each positioned toward outside of the space; and
a speaker,
wherein the instructions that, when executed by the at least one processor individually or collectively, cause the wearable device to:
execute an ambient sound function,
based on executing the ambient sound function:
perform a measurement with respect to a sound of ambient environment of the user using the first outer microphone, and
refrain from performing a measurement with respect to a sound of the ambient environment of the user using the second outer microphone,
obtain sound data according to the measurement performed using the first outer microphone, and
for providing the ambient sound function:
in accordance with a level of the sound data less than or equal to a reference level, output, through the speaker, a sound of the ambient environment based on the sound data obtained using the first outer microphone, and
in accordance with the level of the sound data greater than the reference level, perform the measurement with respect to a sound of ambient environment of the user using the second outer microphone.

2. The wearable device of claim 1,
wherein the wearable device comprises a housing a first housing portion to be worn by the ear portion of the user and a second housing portion to be engaged with the first housing portion,
wherein the first housing portion includes the speaker and the inner microphone from among the plurality of microphones, and
wherein the second housing portion includes:
a head portion including the first outer microphone from among the plurality of microphones, and
a stem portion, including the second outer microphone from among the plurality of microphones, expanded from the head portion.

3. The wearable device of claim 2, wherein the head portion of the second housing portion includes a grill structure to cover at least portion of the first outer microphone from outside of the wearable device.

4. The wearable device of claim 2, wherein the first housing portion includes:
a nozzle used as a path of a sound outputted through the speaker, and
an ear-tip connected to the nozzle.

5. The wearable device of claim 1, wherein the instructions, when executed by the at least one processor individually or collectively, further cause the wearable device to:
obtain another sound data according to the measurement performed using the second outer microphone,
generate a value indicating a noise of the ambient environment based on the sound data and the other sound data, and
in accordance with the value less than or equal to a reference value, cease to perform the measurement with respect to a sound of the ambient environment of the user using the second outer microphone.

6. The wearable device of claim 5, wherein the instructions, when executed by the at least one processor individually or collectively, further cause the wearable device to:
in accordance with the value less than or equal to the reference value, output, through the speaker, a sound of the ambient environment based on the sound data obtained using the second outer microphone.

7. The wearable device of claim 5, wherein the instructions, when executed by the at least one processor individually or collectively, further cause the wearable device to:
in accordance with the value greater than the reference value, adjust a gain value for the ambient sound function according to the value from a first gain value to a second gain value, and
output, through the speaker, a sound of the ambient environment based on the sound data obtained using the first outer microphone, the other sound data obtained using the second outer microphone, and the second gain value.

8. The wearable device of claim 7, wherein the instructions, when executed by the at least one processor individually or collectively, further cause the wearable device to:
in accordance with the level of the sound data less than or equal to the reference level, output, through the speaker, a sound of the ambient environment further based on the first gain value.

9. The wearable device of claim 7, wherein the instructions, when executed by the at least one processor individually or collectively, further cause the wearable device to:
in accordance with the value greater than another reference value greater than the reference value, identify a magnitude of the second gain value as a first magnitude, and
in accordance with the value less than or equal to the other reference value and greater than the reference value, identify the magnitude of the second gain value as a second magnitude different from the first magnitude.

10. The wearable device of claim 1, wherein the instructions, when executed by the at least one processor individually or collectively, further cause the wearable device to:
execute an active noise cancellation (ANC) function, and
execute the ambient sound function while executing the ANC function.

11. The wearable device of claim 1, wherein the instructions, when executed by the at least one processor individually or collectively, further cause the wearable device to:
perform the measurement with respect to a sound of the ambient environment of the user performed using the first outer microphone according to a period, and
perform the measurement with respect to a sound of the ambient environment of the user performed using the second outer microphone according to the period.

12. The wearable device of claim 11, wherein the instructions, when executed by the at least one processor individually or collectively, further cause the wearable device to:
perform the measurement with respect to a sound of the ambient environment of the user performed using the first outer microphone in a first time interval of a time duration according to the period, and
cease to perform the measurement with respect to a sound of the ambient environment of the user performed using the first outer microphone in a second time interval of the time duration according to the period.

13. The wearable device of claim 1, wherein the instructions, when executed by the at least one processor individually or collectively, further cause the wearable device to:
output, through the speaker, a sound of the speaker by suppressing a noise from among a sound of the ambient environment based on the sound data obtained using the first outer microphone, and
wherein the noise is based on a wind of the ambient environment.

14. The wearable device of claim 1, wherein the instructions, when executed by the at least one processor individually or collectively, further cause the wearable device to:
based on executing the ambient sound function, deactivate the second outer microphone by ceasing to provide a power to the second outer microphone.

15. A method performed by a wearable device, being wearable by an ear portion of a user, comprising a plurality of microphones including an inner microphone positioned toward inside of space formed by the wearable device and the ear portion when the wearable device is worn by the ear portion, and a first outer microphone and a second outer microphone each positioned toward outside of the space and a speaker, comprising:
executing an ambient sound function,
based on executing the ambient sound function:
performing a measurement with respect to a sound of ambient environment of the user using the first outer microphone, and
refraining from performing a measurement with respect to a sound of the ambient environment of the user using the second outer microphone,
obtaining sound data according to the measurement performed using the first outer microphone, and
for providing the ambient sound function:
in accordance with a level of the sound data less than or equal to a reference level, outputting, through the speaker, a sound of the ambient environment based on the sound data obtained using the first outer microphone, and
in accordance with the level of the sound data greater than the reference level, performing the measurement with respect to a sound of ambient environment of the user using the second outer microphone.

16. The method of claim 15,
wherein the wearable device comprises a housing a first housing portion to be worn by the ear portion of the user and a second housing portion to be engaged with the first housing portion,
wherein the first housing portion includes the speaker and the inner microphone from among the plurality of microphones, and
wherein the second housing portion includes:
a head portion including the first outer microphone from among the plurality of microphones, and
a stem portion, including the second outer microphone from among the plurality of microphones, expanded from the head portion.

17. The method of claim 16, wherein the head portion of the second housing portion includes a grill structure to cover at least portion of the first outer microphone from outside of the wearable device.

18. The method of claim 16, wherein the first housing portion includes:
a nozzle used as a path of a sound outputted through the speaker, and
an ear-tip connected to the nozzle.

19. The method of claim 18, the method comprising:
in accordance with a value greater than a reference value, adjusting a gain value for the ambient sound function according to the value from a first gain value to a second gain value, and
outputting, through the speaker, a sound of the ambient environment based on the sound data obtained using the first outer microphone, another sound data obtained using the second outer microphone, and the second gain value.

20. A non-transitory computer readable storage medium, when individually or collectively executed by at least one processor of a wearable device, being wearable by an ear portion of a user, comprising a plurality of microphones including an inner microphone positioned toward inside of space formed by the wearable device and the ear portion when the wearable device is worn by the ear portion, and a first outer microphone and a second outer microphone each positioned toward outside of the space and a speaker, storing one or more programs including instructions that cause the wearable device to:
execute an ambient sound function,
based on executing the ambient sound function:
perform a measurement with respect to a sound of ambient environment of the user using the first outer microphone, and
refrain from performing a measurement with respect to a sound of the ambient environment of the user using the second outer microphone,
obtain sound data according to the measurement performed using the first outer microphone, and
for providing the ambient sound function:
in accordance with a level of the sound data less than or equal to a reference level, output, through the speaker, a sound of the ambient environment based on the sound data obtained using the first outer microphone, and
in accordance with the level of the sound data greater than the reference level, perform the measurement with respect to a sound of ambient environment of the user using the second outer microphone.
